(19) United States
(12) Patent Application Publication
(10) Pub. No.: US 2026/0099610 A1
(43) Pub. Date: Apr. 9, 2026

(54) ARTIFICAL INTELLIGENCE-ENABLED CYBERSECURITY THREAT ANALYSIS

(71) Applicant: DISNEY ENTERPRISES, INC., Burbank, CA (US)

(72) Inventor: Christopher Johnson FARRELL, Pasadena, CA (US)

(21) Appl. No.: 18/911,165

(22) Filed: Oct. 9, 2024

(51) Int. Cl. G06F 21/57; G06F 8/65

(52) U.S. Cl. CPC G06F 21/577; G06F 8/65

(57) ABSTRACT

The present disclosure includes techniques for performing automated vulnerability assessment. The technique includes receiving a designation associated with a Common Vulnerabilities and Exposures (CVE) and retrieving one or more attributes describing the CVE. The technique also includes aggregating, by one or more distributed data acquisition operations, CVE data associated with the CVE, wherein the one or more distributed data acquisition operations electronically capture data from a plurality of networked information sources in parallel, and generating, via a first machine learning model, a prompt data structure based on the CVE designation, the one or more attributes, and the CVE data. The technique further includes transmitting the prompt data structure to a second machine learning model that generates a vulnerability assessment, generating one or more CVE reports based on the vulnerability assessment, and performing an automated remediation action based on the one or more CVE reports.

### BACKGROUND

### Field of the Various Embodiments

Embodiments of the present disclosure relate generally to cybersecurity and, more specifically, to techniques for performing automated cybersecurity threat analysis.

### Description of the Related Art

In the field of cybersecurity, vulnerability management is a critical task for evaluating risk to an organization's computing systems. Cybersecurity personnel must continuously evaluate new and existing vulnerabilities to determine both the likelihood that a vulnerability will affect their organization, and the resulting impact on the organization.

Existing techniques for cybersecurity threat analysis may simply evaluate a potential vulnerability based on a rigid scoring metric. These metrics provide a theoretical risk assessment associated with a known vulnerability that often does not reflect the actual risk to an organization based on deployment practices and real-world exploitation of the vulnerability. For example, a metric-based technique may generate a vulnerability score associated with a vulnerability without considering whether the vulnerability has ever actually been exploited in the past, or whether the vulnerability is associated with any computing products employed by the organization.

Other existing techniques may require extensive research, including manual review of vulnerability data from numerous disparate sources to understand the true risk posed by each vulnerability. This manual process is labor-intensive and prone to inconsistency, both in the research sources and methods employed and in the generation of vulnerability reports. These techniques also require that an analyst possess detailed knowledge of an organization's various software, hardware, and other computing products to evaluate the potential risk that a vulnerability poses to the specific organization.

As the foregoing illustrates, what is needed in the art are more effective techniques for performing automated cybersecurity threat analysis.

### SUMMARY

One embodiment of the present invention sets forth a technique for performing automated vulnerability assessment. The technique includes receiving a designation associated with a Common Vulnerabilities and Exposures (CVE) and retrieving one or more attributes describing the CVE. The technique also includes aggregating, by one or more distributed data acquisition operations, CVE data associated with the CVE, wherein the one or more distributed data acquisition operations electronically capture data from a plurality of networked information sources in parallel. The technique further includes generating, via a first machine learning model, a prompt data structure based on the designation, the one or more attributes, and the CVE data, transmitting the prompt data structure to a second machine learning model that generates a vulnerability assessment associated with the CVE based on the prompt data structure. The technique further includes generating one or more CVE reports based on the vulnerability assessment and performing an automated remediation action based on the one or more CVE reports.

One technical advantage of the disclosed techniques relative to the prior art is that the disclosed techniques enable automated end-to-end cybersecurity vulnerability analysis, from the specification of one or more vulnerabilities for analysis to the generation of comprehensive reports based on the analysis. The disclosed techniques also enable customizing a vulnerability analysis to a particular organization, including specifying applications or other computing products in the organization's computing environment or specifying computing products that are of particular significance to the organization. The disclosed techniques further enable customization of preferred and/or non-preferred search resources and formatting/content standards for vulnerability reports, improving both consistency and accuracy in the vulnerability analysis and report generation. These technical advantages provide one or more improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments.

FIG. 2 is a more detailed illustration of the assessment engine of FIG. 1, according to some embodiments.

FIG. 3 is a flow diagram of method steps for performing automated vulnerability analysis, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

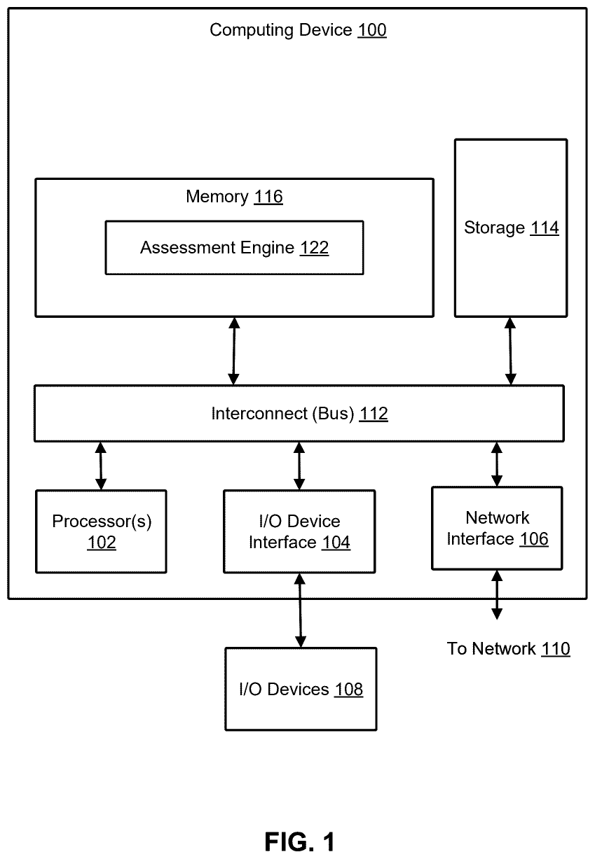

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run an assessment engine 122 that resides in a memory 116.

It is noted that the computing device described herein is illustrative and that any other technically feasible configurations fall within the scope of the present disclosure. For example, multiple instances of assessment engine 122 could execute on a set of nodes in a distributed and/or cloud computing system to implement the functionality of computing device 100. In another example, assessment engine 122 could execute on various sets of hardware, types of devices, or environments to adapt assessment engine 122 to different use cases or applications. In a third example, assessment engine 122 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Assessment engine 122 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including assessment engine 122.

### Single CVE Analysis

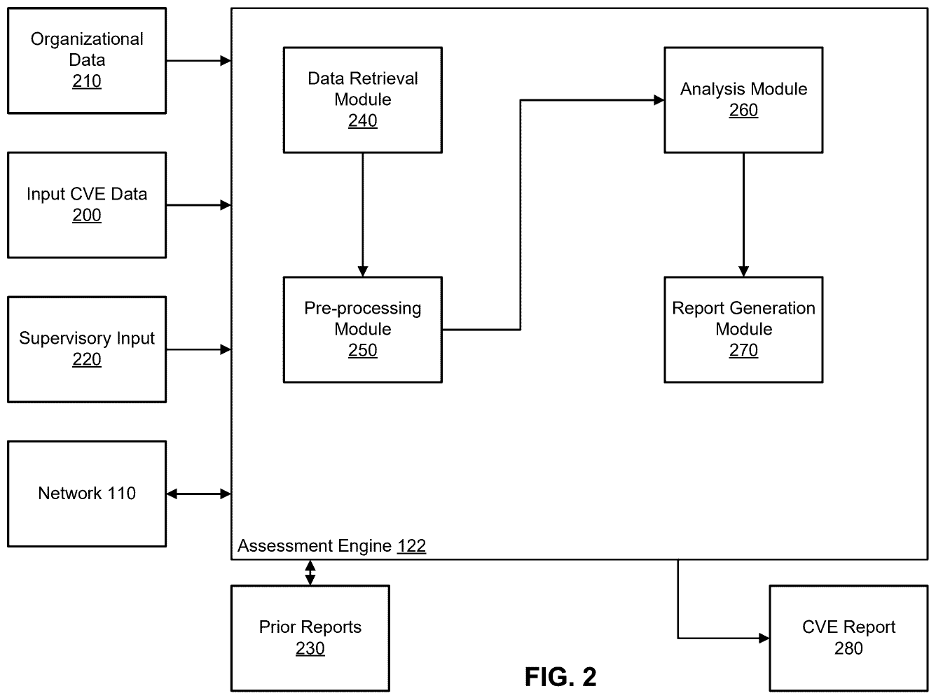

FIG. 2 is a more detailed illustration of assessment engine 122 of FIG. 1, according to some embodiments. Assessment engine 122 receives input Common Vulnerabilities and Exposures (CVE) data 200, organizational data 210, and supervisory input 220, and generates CVE report 280. In various embodiments, CVE report 280 may include one or more reports included in prior reports 230 and associated with previously processed input CVE data. Assessment engine 122 includes, without limitation, data retrieval module 240, pre-processing module 250, analysis module 260, and report generation module 270.

Input CVE data 200 includes a CVE designation associated with common vulnerabilities or exposures. A CVE designation may include a common, unique identifier associated with a publicly known information-security vulnerability in a publicly released software application or package. Designations may be published by one or more authoritative cybersecurity organizations, computer product vendors, and/or third-party coordinators. Assessment engine 122 may retrieve input CVE data 200 from a user or an upstream software application. Assessment engine 122 may analyze the formatting of the CVE designation included in input CVE data 200 and generate an error if the CVE designation is not formatted properly.

Organizational data 210 may include a listing of software applications and/or other computing products present in an organization's enterprise computing environment. The listing may be generated manually, or may be generated automatically based on, e.g., an audit of the organization's enterprise computing environment and/or an automated onboarding process for software applications or other computing products. In various embodiments, organizational data 210 may also include a listing of software applications and/or other computing products that have been designated as having a significant importance or impact to the organization. In various embodiments, organizational data 210 may also include one or more vulnerability assessment standards and/or vulnerability reporting standards associated with the organization.

Supervisory input 220 may include manually entered or scripted instructions that inform and/or modify the operation of assessment engine 122. For example, supervisory input 220 may include instructions to update, rather than re-use, previously generated CVE reports, or to add one or more CVEs to a schedule for automatic periodic analysis. Supervisory input 220 may also include lists of preferred and/or non-preferred information sources to be searched by data retrieval module 240 discussed below, as well as links or other references to one or more computer product vendor advisory websites and/or databases.

Prior reports 230 include previously generated reports associated with one or more previously analyzed CVEs. In various embodiments, when input CVE data 200 includes a CVE for which assessment engine 122 has previously generated a report, assessment engine 122 may retrieve an associated previously generated report from prior reports 230 rather than re-analyzing the CVE and generating a new report. As noted above, directions included in supervisory input 220 may override this behavior and direct assessment engine 122 to instead re-analyze the CVE, generate one or more new reports, and update or replace the previously generated report(s) included in prior reports 230 based on the newly generated report(s). In various embodiments, assessment engine 122 may also retrieve one or more previously generated reports associated with CVEs that are similar to a CVE included in input CVE data 200, regardless of whether prior reports 230 includes a previously generated report associated with the specific CVE included in input CVE data 200. Assessment engine 122 may employ retrieval-augmented generation (RAG) or any other suitable search technique to identify previously generated reports included in prior reports 230. For example, assessment engine 122 may search prior reports 230 for previously generated reports associated with one or more CVEs that share one or more baseline or risk attributes with the CVE included in input CVE data 200. Baseline and risk attributes are described below in the discussion of data retrieval module 240, and may include, without limitation, a vendor name, a product name, a textual description of the CVE, or one or more known attack vectors.

Data retrieval module 240 gathers baseline attributes and/or risk attributes associated with a CVE included in input CVE data 200. Baseline attributes associated with a CVE may include a vendor, a product name, a vulnerability name, and/or a textual description associated with the CVE. Risk attributes associated with a CVE may include a Common Vulnerability Scoring System (CVSS) score, one or more CVSS factors, one or more known attack vectors, one or more privileges and/or authorizations required to exploit the CVE, or the public availability of exploits associated with the CVE. In various embodiments, data retrieval module may gather baseline attributes and/or risk attributes from vendor-provided websites or databases, locally generated organizational databases, and/or third-party websites or databases.

Data retrieval module 240 may determine if a CVE included in input CVE data 200 is documented as having been utilized or exploited “in the wild” - e.g., on devices or computing systems owned or operated by regular users. Exploitation in the wild distinguishes such exploitation from controlled exploitation for research purposes. As an example, data retrieval module 240 may query, via network 110, the Known Exploited Vulnerability (KEV) database maintained by the Cybersecurity and Infrastructure Security Agency (CISA) for documented examples of a particular CVE having been exploited in the wild.

Pre-processing module 250 searches one or more networked information sources for information relevant to a CVE included in input CVE data 200 and processes the relevant information via a machine learning model, such as a large language model (LLM). Pre-processing module 250 may process the search results based on one or more lists of preferred or non-preferred information sources included in supervisory input 220.

Pre-processing module 250 transmits a CVE designation, vulnerability name, and vendor name to one or more networked information sources. Pre-processing module 250 retrieves, by one or more distributed data acquisition operations, one or more search results from the one or more networked information sources, where each search results includes a Uniform Resource Locator (URL) or other link associated with an information source. In various embodiments, pre-processing module 250 may select a predetermined number of search results based on an ordering of the search results included in the one or more distributed data acquisition operations. Pre-processing module 250 may also select or reject a subset of the individual search results based on lists of preferred or non-preferred networked information sources included in supervisory input 220.

Pre-processing module 250 electronically accesses an information source associated with an URL or other link included in a selected search result. Pre-processing module 250 analyzes the information source and captures relevant CVE data from the information source. Pre-processing module 250 may also access, analyze, and capture relevant CVE data from a vendor advisory website or database included in supervisory input 220. In various embodiments, pre-processing module 250 may access and/or analyze multiple information sources sequentially. Additionally or alternatively, pre-processing module 250 may access and/or analyze multiple information sources simultaneously via parallel execution of multiple distributed data acquisition operations.

Pre-processing module 250 transmits the captured CVE data and/or vendor advisory data to a machine learning model included in pre-processing module 250. In various embodiments, the machine learning model may include a Large Language Model (LLM). The LLM processes the captured CVE data and/or vendor advisory data and extracts information related to the searched CVE while ignoring information included in the captured data that is specific to other CVEs. The LLM may also independently assess the information source's evaluation of the searched CVE's attributes, exploitability, and remediation methods. In various embodiments, the LLM may summarize the relevant captured data, such that the quantity of summarized data is smaller than a predetermined LLM token limit. The LLM token limit may be predetermined based on the input requirements of an additional LLM included in analysis module 260 described below. Pre-processing module 250 stores the summarized data and repeats the access/analysis/capturing process for an additional search result included in the selected search results. Pre-processing module 250 pre-processes the additional search result via the LLM and updates the summarized data while maintaining the quantity of summarized data at or below the predetermined LLM token limit. Pre-processing module 250 continues to process additional search results included in the selected search results until the LLM has generated and stored summarized data associated with each of the selected search results. Pre-processing module 250 transmits the CVE designation and the summarized data associated with the CVE to analysis module 260.

Analysis module 260 receives the CVE designation and summarized CVE data from pre-processing module 250. Analysis module 260 processes the CVE data via one or more machine learning models, such as an LLM. In various embodiments, an LLM included in analysis module 260 may be the same LLM as discussed above in reference to pre-processing module 250. In other embodiments, analysis module 260 may include an additional instance of the LLM included in pre-processing module 250, or a different LLM.

Assessment engine 122 may transmit one or more items of organizational data 210 to analysis module 260. For example, assessment engine 122 may transmit a list of one or more computer products included in the organization's enterprise computing environment as specified by organizational data 210. Assessment engine 122 may also transmit one or more organizational standards included in organizational data 210 specifying organization-specific standards for vulnerability assessment and/or vulnerability reporting formats.

Analysis module 260 generates an analysis prompt data structure for an LLM included in analysis module 260. The analysis prompt data structure may include a textual request for the LLM to analyze the CVE and generate a report assessing the risk posed by the CVE, one or more remediation methods associated with the CVE, and/or a list of one or more computer products included in the organization's enterprise computing environment and associated with the CVE. Analysis module 260 may append the analysis prompt data structure with the summarized CVE data generated by pre-processing module 250 to provide context associated with the textual request, or may provide the summarized CVE data to the LLM as a separate contextual prompt.

Similarly, analysis module 260 may append the analysis prompt data structure with one or more items of organizational data 210, or may provide the one or more items of organizational data 210 to the LLM as a separate contextual prompt.

Based on the one or more LLM prompts, the LLM included in analysis module 260 generates a vulnerability assessment of the designated CVE. The vulnerability assessment may include a name and/or designation associated with the CVE and a description of a risk posed by the CVE. In various embodiments, the risk description included in the vulnerability assessment may be expressed as a combination of a likelihood that the CVE will affect a computer product and a potential severity of the CVE's effect on the computer product. The vulnerability assessment may also include one or more remediation methods associated with the CVE, and/or a list of one or more computer products included in the organization's enterprise computing environment that may potentially be affected by the CVE. Analysis module 260 transmits the CVE assessment to report generation module 270.

Report generation module 270 receives a CVE assessment from analysis module 260 and processes the CVE assessment to generate CVE report 280. In some embodiments, report generation module 270 may transmit a generated report to a supervisory user for review prior to generating CVE report 280.

In various embodiments, report generation module 270 may direct analysis module 260 to generate one or more additional vulnerability analyses of a CVE. The number of additional analyses may be specified in supervisory input 220. Report generation module 270 may compare the multiple CVE analyses and detect any inconsistent and/or inaccurate results. Report generation module 270 may flag any potentially hallucinatory results or errors included in the multiple CVE analyses and log the potentially hallucinatory results or errors for future fine-tuning of one or more LLMs included in assessment engine 122. Report generation module 270 may also remove the potentially hallucinatory results or errors prior to generating CVE report 280. Report generation module 270 may aggregate all or portions of the multiple CVE analyses when generating CVE report 280.

Report generation module 270 may identify one or more computer products that are both denoted in organizational data 210 as having particular importance or impact to the organization and identified in the CVE vulnerability assessment(s) as potentially being affected by the analyzed CVE. Report generation module 270 may include the identified computer products in CVE report 280.

Report generation module 270 may transmit a generated report to a supervisory user for review. Report generation module 270 may transmit the generated report directly to the supervisory user via email, text message, instant message, or any other suitable communication method. Alternatively or additionally, report generation module 270 may store the generated report in a supervisory queue for later retrieval by the supervisory user.

CVE report 280 may include a CVE designation, a CVE name, and all or portions of one or more CVE analyses performed by analysis module 260 as described above. CVE report 280 may also include one or more remediation methods associated with the analyzed CVE, a list of computer products associated with the organization that may be vulnerable to the CVE, including a list of potentially vulnerable computer products that are denoted as having high importance or high impact to the organization. In various embodiments, assessment engine 122 may store CVE report 280 in prior reports 230 and/or transmit CVE report 280 to a user, e.g., via network 110 and one or more of I/O devices 108. Assessment engine 122 may also transmit CVE report 280 to one or more downstream software applications.

In various embodiments, assessment engine 122 and/or the one or more downstream software applications may generate an alert based on CVE report 280 and transmit the alert to one or more relevant entities via any suitable messaging service, e.g., email, text/SMS message, or an enterprise instant messaging system.

Assessment engine 122 and/or the one or more downstream software applications may also initiate, via one or more commercially available scanning services, a targeted scan of one or more enterprise computing products identified in CVE report 280 as susceptible to the CVE(s) included in CVE report 280. Assessment engine 122 and/or the one or more downstream software applications may also halt the execution of one or more enterprise computing products identified as susceptible to the CVE(s) or initiate a quarantine of the identified enterprise computing products. Assessment engine 122 and/or the one or more downstream software applications may also automatically initiate installation of one or more patches, re-install an earlier version of a software application upon notification of an identified vulnerability in a newer version of the software application. Assessment engine 122 may also transmit an alert associated with an identified vulnerability to one or more members of a software security team, where the alert may include recommendations for remediation efforts.

Additionally, the one or more software applications may generate, via a generative machine learning model, computer code designed to identify potentially affected devices or other computing products included in the enterprise computing environment. The generated computer code may augment the one or more commercially available scanning services, or may supplant the commercially available scanning services in instances where the one or more commercially available scanning services do not include adequate scanning methods or capabilities related to the CVE(s) and/or computing products included in CVE report 280.

### Multiple CVE Analysis

In various embodiments, assessment engine 122 may analyze multiple CVEs rather than a single CVE, and generate a single report or multiple reports based on the analyses. For example, a supervisory input included in supervisory input 220 may specify that for multiple analyzed CVEs, assessment engine 122 should generate a single vulnerability report including all analyzed CVEs, multiple individual CVE reports grouped by severity, and/or multiple individual CVE reports grouped by common remediation methods.

In various embodiments where assessment engine 122 analyzes multiple CVEs, input CVE data 200 may include a list of multiple CVEs. For each of the multiple CVEs included in input CVE data 200, assessment engine 122 may retrieve and store baseline attributes and/or risk attributes via data retrieval module 240 as described above. Pre-processing module 250 of assessment engine 122 may perform Internet searches, access information sources, and capture relevant CVE data for each of the multiple CVEs included in input CVE data 200.

Analysis module 260 may generate single or multiple vulnerability assessments for multiple CVEs included in input CVE data 200. As described above, instructions included in supervisory input 220 may direct analysis module 260 to generate a single report associated with all CVEs included in input CVE data 200.

Alternatively, instructions included in supervisory input 220 may direct analysis module 260 to generate multiple reports, where each report is associated with a single CVE and the multiple reports are grouped by, e.g., assessed severity of the individual CVEs or common remediation methods associated with the multiple CVEs.

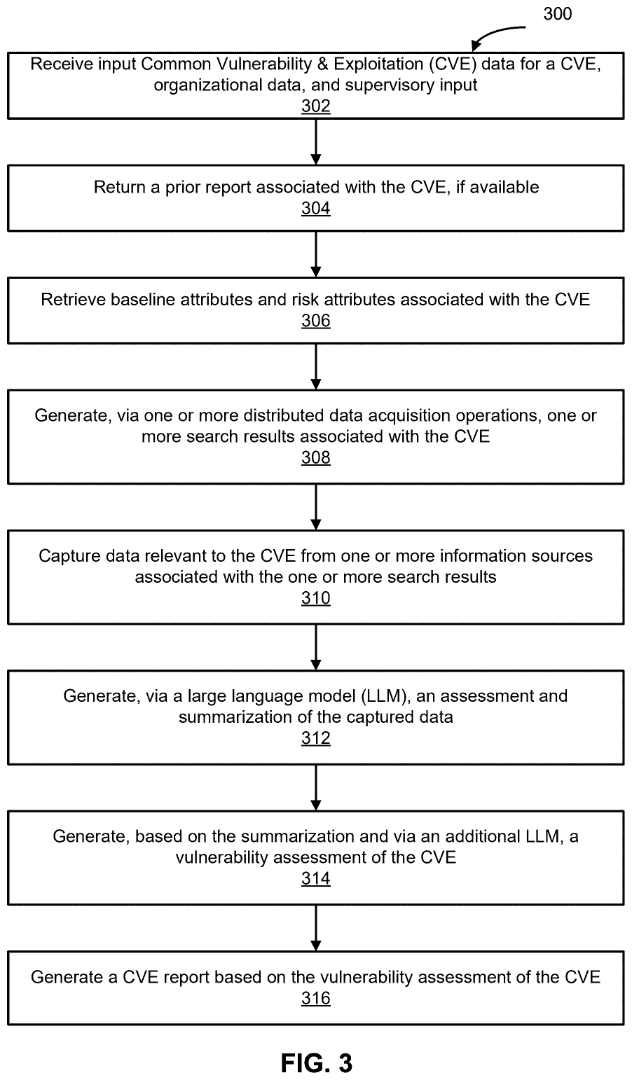

FIG. 3 is a flow diagram of method steps for performing automated vulnerability assessment, according to some embodiments. Although the method steps are described in conjunction with the systems of FIGS. 1 and 2, persons skilled in the art will understand that any system configured to perform the method steps in any order falls within the scope of the present disclosure.

As shown, in operation 302 of method 300, assessment engine 122 receives input CVE data 200, organizational data 210, and supervisory input 220. Input CVE data 200 may include Common Vulnerabilities and Exposures (CVE) designations for one or more CVEs. Organizational data 210 may include a listing of software applications and/or other computing products present in an organization's enterprise computing environment. In various embodiments, organizational data 210 may also include a listing of software applications and/or other computing products that have been designated as having a significant importance or impact to the organization. In various embodiments, organizational data 210 may also include one or more vulnerability assessment standards and/or vulnerability reporting standards associated with the organization.

Supervisory input 220 may include manually entered or scripted instructions that inform and/or modify the operation of assessment engine 122. Supervisory input 220 may include instructions to update, rather than re-use, previously generated CVE reports, or to add one or more CVEs to a schedule for automatic periodic analysis.

Supervisory input 220 may also include lists of preferred and/or non-preferred information sources, as well as links or other references to one or more computer product vendor advisory websites and/or databases. In various embodiments where assessment engine processes multiple CVEs included in input CVE data 200, supervisory input 220 may direct assessment engine to generate a single report for the multiple CVEs, or individual reports for each of the multiple CVEs.

In operation 304, assessment engine 122 determines whether prior reports 230 includes a previously generated report associated with the CVE included in input CVE data 200. Assessment engine 122 may also determine whether prior reports 230 includes previously generated reports associated with one or more CVEs that are similar to the CVE included in input CVE data 200. If prior reports 230 includes a previously generated report associated with the CVE, assessment engine 122 may return the previously generated report as CVE report 280 and terminate assessment.

Assessment engine 122 may return previously generated reports associated with one or more similar CVEs, even if prior reports 230 does not include a previously generated report associated with the CVE included in input CVE data 200. If prior reports 230 does not include a previously generated report associated with the CVE, assessment engine 122 may continue assessing the CVE. Instructions included in supervisory input 220 may modify the operation of assessment engine 122, such that assessment engine 122 may replace or update a previously generated report included in prior reports 230 based on a new assessment of the CVE.

In operation 306, data retrieval module 240 of assessment engine 122 retrieves baseline attributes and/or risk attributes associated with the CVE. Baseline attributes may include a vulnerability name, a vendor name, and/or a computer product name associated with the CVE. Baseline attributes may also include a textual description of the CVE. Risk attributes associated with the CVE may include a Common Vulnerability Scoring System (CVSS) score associated with the CVE, one or more attack vectors associated with the CVE, and/or one or more privileges required to exploit the CVE.

In operation 308, pre-processing module 250 of assessment engine 122 transmits CVE data to one or more Internet search engines and retrieves one or more search results associated with the CVE. Each of the one or more search results may include a Uniform Resource Location (URL) or other link to an information source. Pre-processing module 250 may select a predetermined number of search results based on an ordering of the search results and/or lists of preferred and non-preferred information sources included in supervisory input 220.

In operation 310, pre-processing module 250 analyzes the contents of one or more information sources associated with the selected search results and captures data potentially relevant to the CVE. Pre-processing module 250 stores the captured CVE data for later summarization and processing.

In operation 312, pre-processing module 250 processes the captured CVE data via a machine learning model, such as a large language model (LLM). The LLM aggregates the captured CVE data that is specifically relevant to the CVE, while disregarding irrelevant data. The LLM may also independently assess the information sources'evaluation of the CVE attributes, remediation methods, and/or exploitability.

Pre-processing module 250 may further summarize the aggregated CVE data, such that the quantity of summarized data is smaller than a predetermined LLM token limit. Pre-processing module 250 stores the summarized data and repeats the access/analysis/capture process for an additional search result included in the selected search results. Pre-processing module 250 pre-processes the additional search result via the LLM and updates the summarized data while maintaining the quantity of summarized data at or below the predetermined LLM token limit. Pre-processing module 250 continues to process additional search results included in the selected search results until the LLM has generated and stored summarized data associated with each of the selected search results.

In operation 314, analysis module 260 of assessment engine 122 performs a vulnerability assessment of the CVE based on the summarized data generated by pre-processing module 250. Analysis module 260 processes the CVE data via one or more machine learning models, such as an LLM. In various embodiments, an LLM included in analysis module 260 may be the same LLM as discussed above in reference to pre-processing module 250. In other embodiments, analysis module 260 may include an additional instance of the LLM included in pre-processing module 250, or a different LLM.

Assessment engine 122 may transmit one or more items of organizational data 210 to analysis module 260. For example, assessment engine 122 may transmit a list of one or more computer products included in the organization's enterprise computing environment as specified by organizational data 210. Assessment engine 122 may also transmit one or more organizational standards included in organizational data 210 specifying organization-specific standards for vulnerability assessment and/or vulnerability reporting formats.

Analysis module 260 generates an analysis prompt for an LLM included in analysis module 260. The analysis prompt may include a textual request for the LLM to analyze the CVE and generate a report assessing the risk posed by the CVE, one or more remediation methods associated with the CVE, and/or a list of one or more computer products included in the organization's enterprise computing environment and associated with the CVE. Analysis module 260 may append the analysis prompt with the summarized CVE data generated by pre-processing module 250, or may provide the summarized CVE data to the LLM as a separate prompt. Similarly, analysis module 260 may append the analysis prompt with one or more items of organizational data 210, or may provide the one or more items of organizational data 210 to the LLM as a separate prompt.

Based on the one or more LLM prompts, the LLM included in analysis module 260 generates a vulnerability assessment of the designated CVE. The vulnerability assessment may include a name and/or designation associated with the CVE and a description of a risk posed by the CVE. The vulnerability assessment may also include one or more remediation methods associated with the CVE, and/or a list of one or more computer products included in the organization's enterprise computing environment that may potentially be affected by the CVE.

In operation 316, report generation module 270 of assessment engine 122 generates CVE report 280. CVE report 280 may include a CVE designation, a CVE name, and all or portions of one or more CVE analyses performed by analysis module 260 as described above. CVE report 280 may also include one or more remediation methods associated with the analyzed CVE, a list of computer products associated with the organization that may be vulnerable to the CVE, including a list of potentially vulnerable computer products that are denoted as having high importance or high impact to the organization. In various embodiments, assessment engine 122 may store CVE report 280 in prior reports 230 and/or transmit CVE report 280 to a user, e.g., via network 110 and one or more of I/O devices 108. Assessment engine 122 may also transmit CVE report 280 to one or more downstream software applications.

In various embodiments of the disclosed invention, assessment engine 122 may repeat one or more of the above method steps to assess multiple CVEs included in input CVE data 200. In these embodiments, CVE report 280 may include a single report associated with the multiple CVEs, or CVE report 280 may include separate reports for each of the multiple CVEs, grouped by, e.g., severity of the CVEs or common remediation methods associated with the CVEs.

In sum, the disclosed techniques perform automated assessment of one or more identified cybersecurity vulnerabilities and/or exploits. The disclosed techniques receive one or more Common Vulnerability and Exposures (CVE) signifiers and retrieve information relevant to the CVE(s). The techniques capture information relevant to the identified CVE(s) from the Internet and/or other information sources. The techniques process information relevant to the CVE(s) via one or more machine learning models and generate one or more CVE reports for human review and/or transmission to a downstream software application.

In operation, an assessment engine receives one or more CVE designations, where each CVE designation includes a numeric or alphanumeric reference associated with a unique identified cybersecurity vulnerability or exposure. The assessment engine analyzes the CVE designation(s) and determines if the CVE designation(s) adhere to a specified format. The assessment engine may prompt a user for revision or removal of CVE designation(s) that do not adhere to the specified format.

For each received CVE designation, the assessment engine determines if an associated report has already been generated. If a report has already been generated, the assessment engine returns the previously generated report. If there is no previously generated report, the assessment engine continues processing the CVE.

The assessment engine retrieves basic information associated with the CVE from the Internet and/or one or more additional information sources. The basic information may include baseline attributes associated with the CVE and/or risk attributes associated with the CVE. Baseline attributes associated with the CVE may include, but are not limited to, a specific vendor, a specific product, a vulnerability name, or a description of the CVE. Risk attributes associated with the CVE may include, but are not limited to, a Common Vulnerability Scoring System (CVSS) score, one or more CVSS factors, known attack vector(s), and/or privilege(s) required to execute the CVE. The assessment engine may also query one or more information sources and retrieve one or more Known Exploited Vulnerabilities (KEV) records associated with the CVE.

The assessment engine performs a search of the Internet and/or additional information sources based on the CVE designation, the specific vendor, and the vulnerability name and generates search results. The assessment engine selects a number of the search results based on the relevance of the search results and a comparison of the search results to one or more lists of preferred and/or non-preferred information sources. For each selected search result, the assessment engine captures relevant CVE data from the associated information source based on a lookup Uniform Resource Locator (URL) included in the search result and records the captured data.

The assessment engine may capture relevant CVE data from multiple information sources sequentially, or simultaneously via parallel search operations.

For each selected search result, the assessment engine pre-processes the captured data and identifies portions of the captured data that are relevant to the current CVE. The assessment engine summarizes the collected data and generates a prompt suitable for transmission to a machine learning model, such as a Large Language Model (LLM). The LLM independently assesses the information sources'evaluation of attributes, exploitability metrics, and/or remediation techniques associated with the CVE, and the assessment engine stores the LLM assessment results. The LLM may summarize the collected information for transmission to a downstream machine learning model, such as an additional LLM. The LLM may generate an error if the captured data does not include a sufficient quantity of information relevant to the CVE. The assessment engine continues pre-processing the remaining selected search results.

The assessment engine aggregates the pre-processed data associated with the selected search results into a single CVE data package. The assessment engine presents the CVE data package and an assessment request prompt to a machine learning model, such as an additional LLM. The assessment request prompt may include one or more organizational standards related to vulnerability assessment and/or vulnerability reporting. The CVE data package and/or the assessment request prompt may also specify that the CVE is associated with one or more computing products included in the organization's computing environment.

The assessment engine generates, via the additional LLM, a report based on the CVE data package and the assessment request prompt. In some embodiments, the assessment engine may repeat the report generation multiple times and analyze the multiple generated reports for inconsistencies, errors, or hallucinations generated by the additional LLM. The assessment engine may select portions from one or more of the generated reports for inclusion into a final report. In various embodiments, the assessment engine may also annotate the final report to reflect that a CVE included in the report is associated with one or more computing products included in a list of computing products deemed significant to the organization. The assessment engine may optionally forward the final report and any associated data to a supervisor for review prior to transmitting the final report to one or more of a user or a downstream software application.

In various embodiments of the disclosed techniques, the assessment engine may process a collection of multiple CVEs and generate an individual report for each CVE or a single report associated with the multiple CVEs. The assessment engine may also accept human or scripted supervisory inputs at various stages while processing a single CVE or multiple CVEs. Supervisory inputs may include lists of preferred and/or non-preferred information sources, specification of one or more computing products in an organization's computing environment, or formatting/content standards associated with generated vulnerability reports.

One technical advantage of the disclosed techniques relative to the prior art is that the disclosed techniques enable automated end-to-end cybersecurity vulnerability analysis, from the specification of one or more vulnerabilities for analysis to the generation of comprehensive reports based on the analysis. The disclosed techniques also enable customizing a vulnerability analysis to a particular organization, including specifying applications or other computing products in the organization's computing environment or specifying computing products that are of particular significance to the organization. The disclosed techniques further enable customization of preferred and/or non-preferred search resources and formatting/content standards for vulnerability reports, improving both consistency and accuracy in the vulnerability analysis and report generation. These technical advantages provide one or more improvements over prior art approaches.
1. In some embodiments, a computer-implemented method for performing automated vulnerability assessment, the computer-implemented method comprises receiving a designation associated with a Common Vulnerabilities and Exposures (CVE), retrieving one or more attributes describing the CVE, aggregating, by one or more distributed data acquisition operations, CVE data associated with the CVE, wherein the one or more distributed data acquisition operations electronically capture data from a plurality of networked information sources in parallel, generating, via a first machine learning model, a prompt data structure based on the designation, the one or more attributes, and the CVE data, transmitting the prompt data structure to a second machine learning model that generates a vulnerability assessment associated with the CVE based on the prompt data structure, generating one or more CVE reports based on the vulnerability assessment, and performing an automated remediation action based on the one or more CVE reports.
2. The computer-implemented method of clause 1, wherein the one or more attributes describing the CVE include at least one of a vendor name, a product name, a vulnerability name, or a textual description associated with the CVE.
3. The computer-implemented method of clauses 1 or 2, wherein the one or more attributes describing the CVE include at least one of a Common Vulnerability Scoring System (CVSS) score, one or more CVSS factors, one or more known attack vectors, or one or more privileges required to exploit the CVE.
4. The computer-implemented method of any of clauses 1-3, wherein each of the first and second machine learning models include a large language model (LLM).
5. The computer-implemented method of any of clauses 1-4, further comprising retrieving one or more items of organizational data associated with an enterprise computing environment, wherein the organizational data includes a list of one or more software applications or computer products included in the enterprise computing environment.
6. The computer-implemented method of any of clauses 1-5, wherein the automated remediation action includes one or more of initiating an automated vulnerability scan of one or more computing devices included in an enterprise computing environment, automatically isolating or blocking one or more computing devices or software applications, automatically applying software patches to one or more computing devices or software applications, automatically reverting one or more computing devices or software applications to an earlier software version, or automatically transmitting an alert to one or more members of a software security team.
7. The computer-implemented method of any of clauses 1-6, further comprising receiving one or more additional designations associated with one or more additional CVEs, and generating one or more CVE reports based on at least the designation and the one or more additional designations.
8. The computer-implemented method of any of clauses 1-7, further comprising selecting a subset of the aggregated CVE data based on a list of preferred information sources or a list of non-preferred information sources.
9. The computer-implemented method of any of clauses 1-8, further comprising summarizing the aggregated CVE data based at least on a predetermined token limit associated with the second machine learning model.
10.The computer-implemented method of any of clauses 1-9, further comprising determining that a database of previously generated CVE reports includes one or more previously generated CVE reports associated with the CVE, retrieving the one or more previously generated CVE reports, and generating one or more CVE reports based on the previously generated CVE reports.
11.In some embodiments, one or more non-transitory computer-readable media store instructions that, when executed by one or more processors, cause the one or more processors to perform the steps of receiving a designation associated with a Common Vulnerabilities and Exposures (CVE), retrieving one or more attributes describing the CVE, aggregating, by one or more distributed data acquisition operations, CVE data associated with the CVE, wherein the one or more distributed data acquisition operations electronically capture data from a plurality of networked information sources in parallel, generating, via a first machine learning model, a prompt data structure based on the designation, the one or more attributes, and the CVE data, transmitting the prompt data structure to a second machine learning model that generates a vulnerability assessment associated with the CVE based on the prompt data structure, generating one or more CVE reports based on the vulnerability assessment, and performing an automated remediation action based on the one or more CVE reports.
12.The one or more non-transitory computer-readable media of clause 11, wherein the one or more attributes describing the CVE include at least one of a vendor name, a product name, a vulnerability name, or a textual description associated with the CVE.
13.The one or more non-transitory computer-readable media of clauses 11 or 12, wherein the one or more attributes describing the CVE include at least one of a Common Vulnerability Scoring System (CVSS) score, one or more CVSS factors, one or more known attack vectors, or one or more privileges required to exploit the CVE.
14.The one or more non-transitory computer-readable media of any of clauses 11-13, wherein each of the first and second machine learning models include a large language model (LLM).
15.The one or more non-transitory computer-readable media of any of clauses 11-14, wherein the instructions further cause the one or more processors to perform the step of retrieving one or more items of organizational data associated with an enterprise computing environment, wherein the organizational data includes a list of one or more software applications or computer products included in the enterprise computing environment.
16.The one or more non-transitory computer-readable media of any of clauses 11-15, wherein the automated remediation action includes one or more of initiating an automated vulnerability scan of one or more computing devices included in an enterprise computing environment, automatically isolating or blocking one or more computing devices or software applications, automatically applying software patches to one or more computing devices or software applications, automatically reverting one or more computing devices or software applications to an earlier software version, or automatically transmitting an alert to one or more members of a software security team.
17.The one or more non-transitory computer-readable media of any of clauses 11-16, wherein the instructions further cause the one or more processors to perform the steps of receiving one or more additional designations associated with one or more additional CVEs, and generating one or more CVE reports based on at least the designation and the one or more additional designations.
18.In some embodiments, a system comprises one or more memories storing instructions, and one or more processors for executing the instructions to receive a designation associated with a Common Vulnerabilities and Exposures (CVE), retrieve one or more attributes describing the CVE, aggregate, by one or more distributed data acquisition operations, CVE data associated with the CVE, wherein the one or more distributed data acquisition operations electronically capture data from a plurality of networked information sources in parallel, generate, via a first machine learning model, a prompt data structure based on the designation, the one or more attributes, and the CVE data, transmit the prompt data structure to a second machine learning model that generates a vulnerability assessment associated with the CVE based on the prompt data structure, generate one or more CVE reports based on the vulnerability assessment, and perform an automated remediation action based on the one or more CVE reports.
19.The system of clause 18, wherein the one or more processors further execute the instructions to select a subset of the aggregated CVE data based on a list of preferred information sources or a list of non-preferred information sources.
20.The system of clauses 18 or 19, wherein the one or more processors further execute the instructions to summarize the aggregated CVE data based at least on a predetermined token limit associated with the second machine learning model.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer. ” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine.

The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing automated vulnerability assessment, the computer-implemented method comprising:
receiving a designation associated with a Common Vulnerabilities and Exposures (CVE);
retrieving one or more attributes describing the CVE;
aggregating, by one or more distributed data acquisition operations, CVE data associated with the CVE, wherein the one or more distributed data acquisition operations electronically capture data from a plurality of networked information sources in parallel;
generating, via a first machine learning model, a prompt data structure based on the designation, the one or more attributes, and the CVE data;
transmitting the prompt data structure to a second machine learning model that generates a vulnerability assessment associated with the CVE based on the prompt data structure;
generating one or more CVE reports based on the vulnerability assessment; and
performing an automated remediation action based on the one or more CVE reports.

2. The computer-implemented method of claim 1, wherein the one or more attributes describing the CVE include at least one of a vendor name, a product name, a vulnerability name, or a textual description associated with the CVE.

3. The computer-implemented method of claim 1, wherein the one or more attributes describing the CVE include at least one of a Common Vulnerability Scoring System (CVSS) score, one or more CVSS factors, one or more known attack vectors, or one or more privileges required to exploit the CVE.

4. The computer-implemented method of claim 1, wherein each of the first and second machine learning models include a large language model (LLM).

5. The computer-implemented method of claim 1, further comprising retrieving one or more items of organizational data associated with an enterprise computing environment, wherein the organizational data includes a list of one or more software applications or computer products included in the enterprise computing environment.

6. The computer-implemented method of claim 1, wherein the automated remediation action includes one or more of initiating an automated vulnerability scan of one or more computing devices included in an enterprise computing environment, automatically isolating or blocking one or more computing devices or software applications, automatically applying software patches to one or more computing devices or software applications, automatically reverting one or more computing devices or software applications to an earlier software version, or automatically transmitting an alert to one or more members of a software security team.

7. The computer-implemented method of claim 1, further comprising:
receiving one or more additional designations associated with one or more additional CVEs; and
generating one or more CVE reports based on at least the designation and the one or more additional designations.

8. The computer-implemented method of claim 1, further comprising selecting a subset of the aggregated CVE data based on a list of preferred information sources or a list of non-preferred information sources.

9. The computer-implemented method of claim 1, further comprising summarizing the aggregated CVE data based at least on a predetermined token limit associated with the second machine learning model.

10. The computer-implemented method of claim 1, further comprising:
determining that a database of previously generated CVE reports includes one or more previously generated CVE reports associated with the CVE;
retrieving the one or more previously generated CVE reports; and
generating one or more CVE reports based on the previously generated CVE reports.

11. One or more non-transitory computer-readable media storing instructions that, when executed by one or more processors, cause the one or more processors to perform the steps of:
receiving a designation associated with a Common Vulnerabilities and Exposures (CVE);
retrieving one or more attributes describing the CVE;
aggregating, by one or more distributed data acquisition operations, CVE data associated with the CVE, wherein the one or more distributed data acquisition operations electronically capture data from a plurality of networked information sources in parallel;
generating, via a first machine learning model, a prompt data structure based on the designation, the one or more attributes, and the CVE data;
transmitting the prompt data structure to a second machine learning model that generates a vulnerability assessment associated with the CVE based on the prompt data structure;
generating one or more CVE reports based on the vulnerability assessment; and
performing an automated remediation action based on the one or more CVE reports.

12. The one or more non-transitory computer-readable media of claim 11, wherein the one or more attributes describing the CVE include at least one of a vendor name, a product name, a vulnerability name, or a textual description associated with the CVE.

13. The one or more non-transitory computer-readable media of claim 11, wherein the one or more attributes describing the CVE include at least one of a Common Vulnerability Scoring System (CVSS) score, one or more CVSS factors, one or more known attack vectors, or one or more privileges required to exploit the CVE.

14. The one or more non-transitory computer-readable media of claim 11, wherein each of the first and second machine learning models include a large language model (LLM).

15. The one or more non-transitory computer-readable media of claim 11, wherein the instructions further cause the one or more processors to perform the step of retrieving one or more items of organizational data associated with an enterprise computing environment, wherein the organizational data includes a list of one or more software applications or computer products included in the enterprise computing environment.

16. The one or more non-transitory computer-readable media of claim 11, wherein the automated remediation action includes one or more of initiating an automated vulnerability scan of one or more computing devices included in an enterprise computing environment, automatically isolating or blocking one or more computing devices or software applications, automatically applying software patches to one or more computing devices or software applications, automatically reverting one or more computing devices or software applications to an earlier software version, or automatically transmitting an alert to one or more members of a software security team.

17. The one or more non-transitory computer-readable media of claim 11, wherein the instructions further cause the one or more processors to perform the steps of:
receiving one or more additional designations associated with one or more additional CVEs; and
generating one or more CVE reports based on at least the designation and the one or more additional designations.

18. A system comprising:
one or more memories storing instructions; and
one or more processors for executing the instructions to:
receive a designation associated with a Common Vulnerabilities and Exposures (CVE);
retrieve one or more attributes describing the CVE;
aggregate, by one or more distributed data acquisition operations, CVE data associated with the CVE, wherein the one or more distributed data acquisition operations electronically capture data from a plurality of networked information sources in parallel;
generate, via a first machine learning model, a prompt data structure based on the designation, the one or more attributes, and the CVE data;
transmit the prompt data structure to a second machine learning model that generates a vulnerability assessment associated with the CVE based on the prompt data structure;
generate one or more CVE reports based on the vulnerability assessment; and
perform an automated remediation action based on the one or more CVE reports.

19. The system of claim 18, wherein the one or more processors further execute the instructions to select a subset of the aggregated CVE data based on a list of preferred information sources or a list of non-preferred information sources.

20. The system of claim 18, wherein the one or more processors further execute the instructions to summarize the aggregated CVE data based at least on a predetermined token limit associated with the second machine learning model.
